(19) United States
(12) Patent Application Publication
(10) Pub. No.: US 2003/0231111 A1
(43) Pub. Date: Dec. 18, 2003

(54) Household marker system and method for detecting household features

(76) Inventor: Richard Gaetzke, Phoenix, AZ (US)

Correspondence Address: WEISS & MOY PC, 4204 NORTH BROWN AVENUE, SCOTTSDALE, AZ, 85251, US

(21) Appl. No.: 10/170,261

(22) Filed: Jun. 13, 2002

(51) Int. Cl. G08B 13/14

(52) U.S. Cl. 340/568.1; 340/572.1

(57) ABSTRACT

A household marker system and method for detecting household features facilitates location of line hidden inside a structure, such as natural gas piping, plumbing and electrical lines. The system and method further provide location of property boundaries of a household, making it possible for a householder to detect their property boundaries without requiring a survey. The system includes one or more markers and a detector. The detector radiates an electromagnetic field at one or more frequencies. The markers resonate at a predetermined frequency and re-radiate an electromagnetic field at the predetermined frequency. The detector detects the re-radiated field and provides an indication of intensity of the re-radiated field so that the location of the marker may be determined by the intensity.

### BACKGROUND OF THE INVENTION

1. Field of the Invention

The present invention relates generally to marker systems, and more specifically, to a marker system for locating various household features.

2. Background of the Invention

Household features such as gas lines, water supply lines or electrical wiring embedded within walls, floors, or ceilings are difficult to locate after construction has been completed. Drawings are not typically available with this level of detail and may be difficult to find in times when they are needed, such as in a gas leak emergency or during remodeling of the household. Typically, a professional service is needed to locate the pipes or wires, and even with professional assistance, disassembly of a portion of the construction may be necessary.

Leak detectors are available for both water and gas leaks, but they give no exact indication of where the leaky system is installed within the construction. Marker systems are available for locating underground valves and other public systems features by utility companies, but these markers have not been adapted for use within a household.

Another feature of interest associated with a household is the household property line. Surveyors are typically required when the location of a property boundary must be determined. Marker systems have been used to locate archaeological features, but a household property line locator system is not currently available.

Therefore, it would be desirable to provide a system and method for locating household features. It would further be desirable to provide a system and method that may be easily used in the event of an emergency such as a gas leak.

### SUMMARY OF THE INVENTION

The above objective of locating household features is achieved in a system and method providing detection of previously implanted markers. The system includes one or more markers and a detector. The detector radiates an electromagnetic field at one or more frequencies and the marker resonates at a predetermined frequency and re-radiates energy at that frequency. The detector detects the intensity of the re-radiated field and provides an intensity indication so that the exact location of the marker may be determined by the location of maximum re-radiation from the marker.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a pictorial diagram depicting use of a system in accordance with an embodiment of the present invention to detect the boundaries of a household.

FIG. 2 is a pictorial depicting a buried marker for use in a system in accordance with an embodiment of the present invention.

FIG. 2A is a schematic diagram of a marker circuit.

FIG. 3 is a view showing markers buried around a household in accordance with an embodiment of the present invention.

FIG. 4 is a pictorial diagram depicting use of a system in accordance with a second embodiment of the present invention to detect hidden features in a wall of a household.

FIG. 5 is a detailed pictorial diagram showing an alternative mounting configuration in accordance with an embodiment of the invention.

FIG. 6 is a pictorial diagram depicting the internal structure of a marker in accordance with an embodiment of the present invention.

### DETAILED DESCRIPTION OF THE EMBODIMENTS

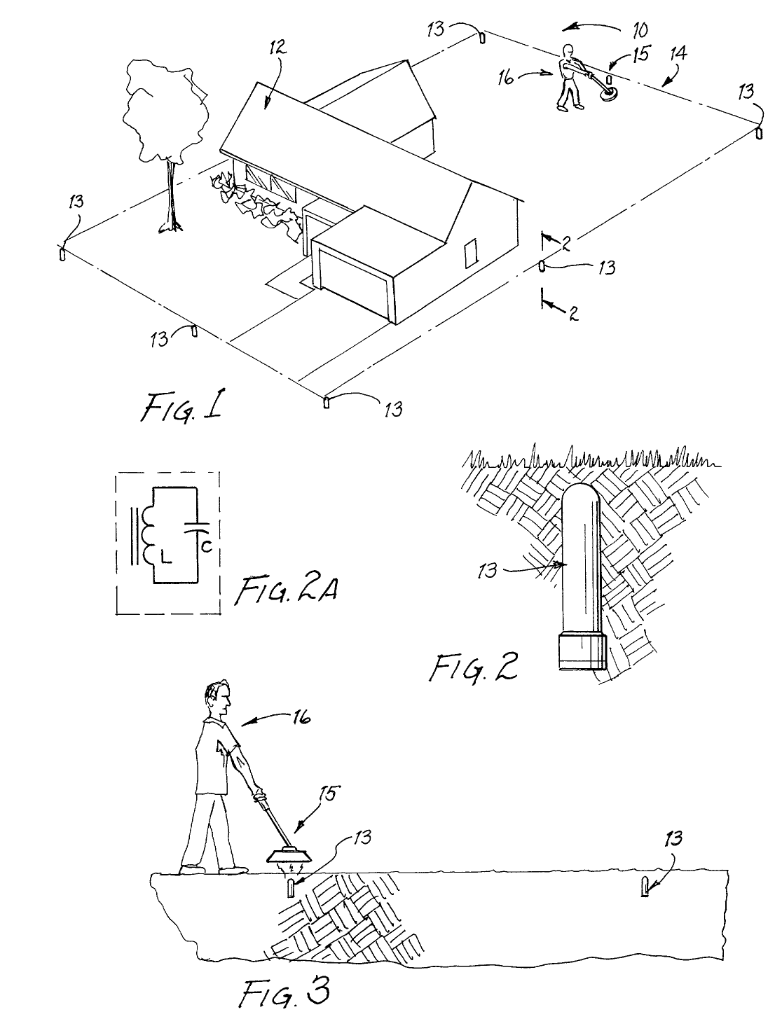

Referring now to the figures and in particular to FIG. 1, a system in use at a household site in accordance with an embodiment of the present invention is shown. A household property 10 shown with a constructed house 12 and defined by a boundary 14. Boundary 14 is typically determined by a survey, in which professionals using sophisticated and relatively expensive instruments determine the corners and lines of boundary 14.

In the method of the present invention, markers 13 are buried at the edges of property 10 and are used to determine the property boundary by an operator 16 using a detector 15. Detector 15 can be relatively inexpensive to manufacture in large quantities. Using a coil and a frequency generator, the detector emits an electromagnetic field at one or more frequencies. FIG. 3 is a more detailed view of operator 16 using detector 15 to locate buried markers 13.

Referring now to FIG. 2, marker 13 is illustrated in detail. A plastic housing encloses marker 13 to protect marker 13 from damage due to moisture, soil acidity and fungus, among other environmental effects. Referring to FIG. 6, the electrical details of marker 13 are shown. A ferrite rod 31 is wound with insulated wire 33 to form a coil and a capacitor 32 is wired in parallel. The electrical circuit is shown in FIG. 2A, with a capacitance and inductance in parallel. When detector 15 applies a signal to its internal coil and the coil is brought in proximity with marker 13, a signal is induced in the parallel marker circuit and a field is re-radiated by ferrite rod 31. Detector 15 may either stop transmitting and measure the decaying field produced by marker 13 or may measure the effect of the field (enhancement of amplitude at the detector coil) to produce an indication of the intensity of the re-radiated field. The indicator may be a binary LED indicator or a digital or analog meter indicating field strength. Alternatively an audible indicator may be used with a tone or pulse frequency determined by the strength of the re-radiated field. Any or all of the above indications may be used to direct operator 16 in moving detector 15 toward marker 13. At the maximum intensity of the re-radiated field, the closest location of marker 13 has been found, permitting a homeowner or a service to locate the property boundary 14 without requiring a survey team.

Detector 15 may emit a signal having multiple frequencies, or may emit a single frequency. Generally, the marker circuit (FIG. 2A) should be tuned to resonance at the operating frequency of detector 13, since the re-radiated field will be much stronger at the resonance frequency. Multiple marker tunings may be used to identify different sets of markers. Detector 15 may also have a switch or other selection mechanism for selecting a single operating frequency, so that a uniquely tuned set of markers may be detected.

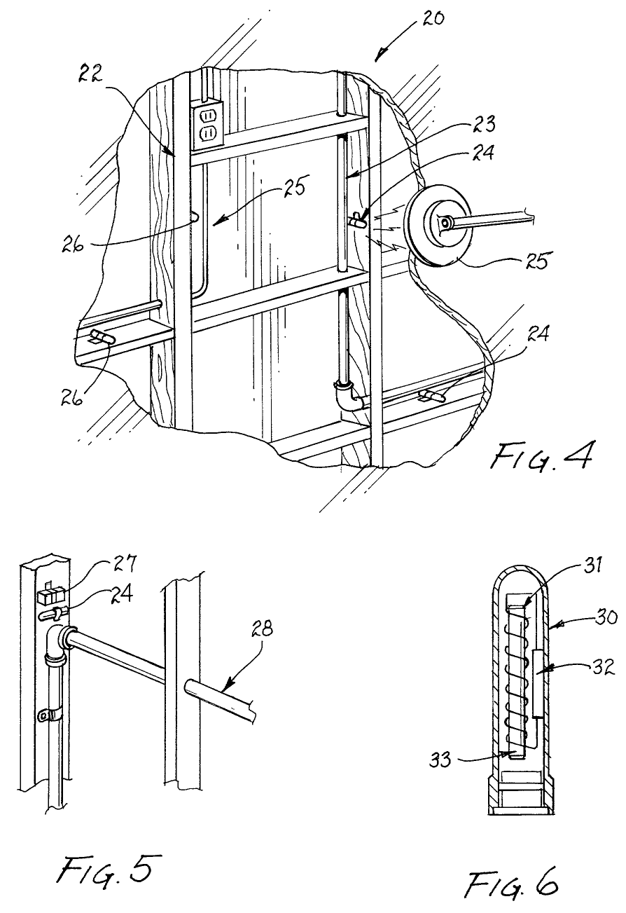

Referring now to FIG. 4 a system in accordance with a second embodiment of the invention is depicted. A wall 20 is shown within a house. Wall 20 is cut-away so that various system lines (e.g., gas, water supply, electrical wiring) can be seen. Electrical wiring line 25 is shown and markers 26 are co-located with the line. Natural gas line 23 is shown with markers 24 co-located. Markers 26 and markers 24 may be easily distinguished by different resonant tunings, even if they are set in locations that are very close. Markers 26 and markers 24 are affixed near their corresponding household features (system lines) and can be attached to wall studs 22 or the lines 24, 23 themselves by an adhesive, tape or clamp. FIG. 5 depicts a marker 27 affixed to a water supply line 28 using tape. The tape used should have an adhesive lifetime exceeding the structure's expected lifespan. Affixing a marker to a wall stud may be accomplished by nailing through housing 13, which is made of a nailable plastic material that will not shatter when affixed to wall stud 24.

Referring now to FIG. 5, a marker 24 co-located with a gas line 28 and a gas leak detector 27 in accordance with an embodiment of the invention is shown. When gas leak detector emits an audible alarm indicating that a gas leak is present, the location of the detector and gas line may be quickly determined by positioning detector 25 near marker 24 where the audible alarm is heard.

The present invention provides a low-cost system for accomplishing repairs involving hidden household system lines and determining household property boundaries. Both of the above may be accomplished with a single detector using multiple markers.

While the invention has been particularly shown and described with reference to the preferred embodiments thereof, it will be understood by those skilled in the art that the foregoing and other changes in form, and details may be made therein without departing from the spirit and scope of the invention.

For example, there may be other uses for the markers and detectors discussed herein. One such use would be to mark the location of land mines, with the marker detectable by a specialized operating frequency known to the entity placing the mines. This would give such entity the ability to locate and perhaps later remove unused mines from an area that has become secure. The marker could also, in combination with detonation means located on the mine, be used by the placing entity to remote detonate mines from air airplanes, drones, or the like.

What is claimed is:

1. A marker system for locating household features, comprising:
at least one marker co-located with a corresponding one of said household features; and
a detector for detecting a location of said at least one marker, whereby a location of said corresponding household feature may be determined.

2. The marker system of claim 1, wherein said at least one marker comprises an electromagnetic resonator and wherein said detector comprises an electromagnetic coupler for exciting a signal within said resonator, whereby a re-radiation from said resonator may be detected by said detector to determined said location of said household feature.

3. The marker system of claim 2, wherein said at least one marker comprises:
a ferrite rod;
a wire coil wrapped around said rod; and
a capacitor having a first terminal connected to a first end of said coil and a second terminal coupled to a second end of said coil, whereby a resonant tank is formed.

4. The marker system of claim 2, wherein said detector comprises an indicator for indicating the amplitude of said re-radiation, whereby said location of said at least one marker may be determined by detecting a maximum of said amplitude when said detector is moved near said at least one marker.

5. The marker system of claim 2, wherein said electromagnetic coupler comprises a coil with multiple windings.

6. The marker system of claim 1, wherein said at least one marker is located underground on a line defining a boundary of said household, whereby said boundary of said household may be detected using said detector.

7. The marker system of claim 1, wherein said at least one marker is co-located with a gas line hidden within the structure of said household, whereby location of said gas line may be detected.

8. The marker system of claim 1, further comprising a gas leak detector co-located with said at least one marker, whereby the location of a gas leak may be detected.

9. The marker system of claim 8, wherein said gas leak detector comprises a sonic transducer, whereby an audible alarm may be emitted when said gas leak occurs.

10. The marker system of claim 1, wherein at least one marker is co-located with a water line hidden within the structure of said household, whereby location of said water line may be detected.

11. The marker system of claim 1, wherein said at least one marker further comprises a housing fabricated from a nailable material and having an extension wherein internal circuity is absent, whereby a nail may be inserted therethrough for attaching said marker to a structure member of said household without damaging said marker.

12. The marker system of claim 11, wherein said housing is a substantially cylindrical plastic housing.

13. A marker system for locating household features, comprising:
means for marking said household features; and
means for detecting a location of said marking means, whereby a location of a corresponding household feature may be determined.

14. The marker system of claim 13, wherein said household features are property boundary locations and wherein said detecting means detects a household property boundary.

15. The marker system of claim 13, wherein said household features are hidden system lines within said household structure and wherein said detecting means detects said hidden system lines.

16. A method for detecting household features, comprising:
co-locating markers with corresponding household features; and
detecting a location of said markers.

17. The method of claim 16, wherein said detecting comprises:
generating an electromagnetic field at one or more frequencies;
re-radiating an electromagnetic field at a predetermined one of said one or more frequencies; and
detecting a maximum intensity of said re-radiated electromagnetic field.

18. The method of claim 16, further comprising burying said marker at a boundary line of said household and wherein said detecting detects a location of said boundary line.

19. The method of claim 16, further comprising installing said marker within a structure of said household near a hidden system line and wherein said detecting locates said hidden system line.

20. The method of claim 19, wherein said hidden system line is a gas line and further comprising generating an audible alarm at said gas line, whereby said detecting may be performed in response to said alarm.
